(19) United States
(12) Patent Application Publication
(10) Pub. No.: US 2001/0045036 A1
(43) Pub. Date: Nov. 29, 2001

(54) Oil change reminder

(76) Inventors: John D. Maxwell, Garden Grove, CA (US); Thomas J. Maxwell, Garden Grove, CA (US)

Correspondence Address: Matthew J. Peirce, Esq., 1550 Starlight Canyon Avenue, Las Vegas, NV, 89123, US

(21) Appl. No.: 09/779,042

(22) Filed: Feb. 7, 2001

Related U.S. Application Data
(60) Provisional application No. 60/180,720, filed on Feb. 7, 2000.

(51) Int. Cl. G09F 21/04

(52) U.S. Cl. 40/593

(57) ABSTRACT

A product is disclosed to assist a vehicle owner and user in properly keeping track of the amount of miles driven in a particular vehicle. The goal of the product is to ensure that regular oil changes will occur approximately every 3,000 miles, which is the usual recommended interval that oil changes occur for most vehicles. The product is a multipage notepad which is preferably one inch tall by one and one-half inches wide, and which can be fastened to an automobile dashboard by means of a mounted Velcro tab, with an accompanying Velcro tab mounted onto the dashboard. The product is designed to provide a user with the ability to perform a quick mathematical calculation in order to determine whether it is presently time to perform an oil change.

### BACKGROUND OF THE INVENTION

The present invention concerns that of a new and improved apparatus for assisting a vehicle owner in properly monitoring the mileage in between oil changes.

### II. DESCRIPTION OF THE PRIOR ART

U.S. Pat. No. 4,069,606, issued to Shevin et al., discloses a holder for removably retaining a card or strip which contains information in a displayed position.

U.S. Pat. No. 1,860,632, issued to Stone, discloses a mileage record holder for automobiles.

U.S. Pat. No. 1,697,700, issued to Tucker et al., discloses a card holder for automobiles for holding memoranda or license cards in position upon the instrument board of an automobile.

U.S. Pat. No. 1,514,464, issued to Ruckman, discloses a device for keeping numerous records, including the recording of data relating to the kind of oil used in an automobile or other motor, the date at which the crank case was drained and filled with new oil, and the speedometer reading at such date.

### III. SUMMARY OF THE INVENTION

The present invention is that of a new and improved product designed to assist a vehicle owner and user in properly keeping track of the amount of miles driven in a particular vehicle. The goal of the product is to ensure that regular oil changes will occur approximately every 3,000 miles, which is the usual recommended interval that oil changes occur for most vehicles. The product is a multi-page notepad which is preferably one inch tall by one and one-half inches wide, and which can be fastened to an automobile dashboard by means of a mounted Velcro tab, with an accompanying Velcro tab mounted onto the dashboard. The product is designed to provide a user with the ability to perform a quick mathematical calculation in order to determine whether it is presently time to perform an oil change.

In this respect, before explaining at least one embodiment of the oil change reminder apparatus in detail, it is to be understood that the oil change reminder apparatus is not limited in its application to the details of construction and to the arrangements of the components set forth in the following description or illustrated in the drawings. The oil change reminder apparatus is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present oil change reminder apparatus. It is important, therefore, that the claims be regard as including such equivalent constructions insofar as they do not depart from the spirit and scope of the present invention.

It is therefore an object of the present invention to provide an oil change reminder apparatus which has all of the advantages of the prior art and none of the disadvantages.

It is another object of the present invention to provide an oil change reminder apparatus which may be easily and efficiently manufactured and marketed.

It is another object of the present invention to provide an oil change reminder apparatus which is of durable and reliable construction.

It is yet another object of the present invention to provide an oil change reminder apparatus which is economically affordable and available to the buying public.

Other objects, features and advantages of the present invention will become more readily apparent from the following detailed description of the preferred embodiment when considered with the attached drawings and appended claims.

### IV. BRIEF DESCRIPTION OF THE DRAWINGS

FIG. 1 is a front view of a specific page, not yet used, of the present invention.

FIG. 2 is a front view of the present invention as it would appear packaged and ready for purchase.

FIG. 3 is an enclosed instruction card that would be enclosed with the present invention.

FIG. 4 is a front view of a dashboard of a vehicle, showing one of many possible preferred placements of the present invention on a dashboard.

### V. DESCRIPTION OF THE PREFERRED EMBODIMENT

FIG. 1 shows a front view of a specific page 4, not yet used, of the oil change reminder 1. The present invention would preferably include at least twenty-five pages 4 located in a notepad 2, with the notepad 2 being approximately one inch in height and one and one-half inches in width Notepad 2 would be attached to backing 7, with backing 7 including a front surface and a rear surface. Backing 7 would have a front surface and a rear surface, with the rear surface of backing 7 including a male Velcro tab 10 fixedly mounted and extending outward from the rear surface Male Velcro tab 10 would preferably be three-fourths of an inch by three-fourths of an inch, or at least big enough to sufficiently attach notepad 2 to a fixed surface.

Each page 4 would have five lines of printing 6 on it. The first line of printing 6 would state in capital letters, “LAST OIL CHANGE.” The second line of printing 6 would be a blank line. The third line of printing 6 would state in capital letters, “NEXT OIL CHANGE.” The fourth line of printing 6 would be a blank line. The fifth line of printing 6 would include the numbers of any valid patents or “patent pending” references with regards to the present invention, along with a copyright designation, which would indicate that the present invention has either secured appropriate intellectual property protection or has appropriate intellectual property protection filed on its behalf.

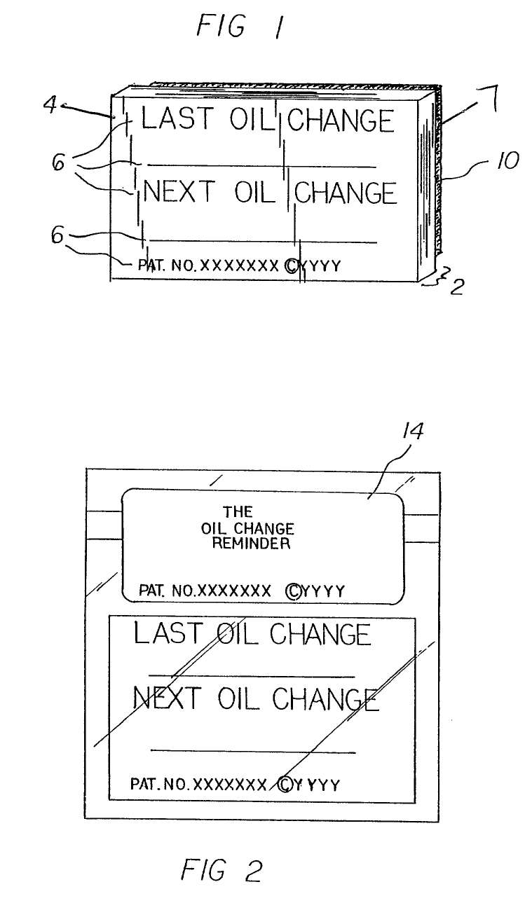

FIG. 2 is a front view of the product as it would be packaged and appear in stores. Product reference label 14 would include the title of the invention and would preferably be ¾ inch tall and 1½ inch wide. Product reference label 14 would also include the numbers of any valid patents or “patent pending” references with regards to the present invention, along with a copyright designation, which will indicate that the present invention has appropriate protection filed on its behalf and hopefully prevent a possible infringer from stealing the idea if he or she saw the present invention for sale.

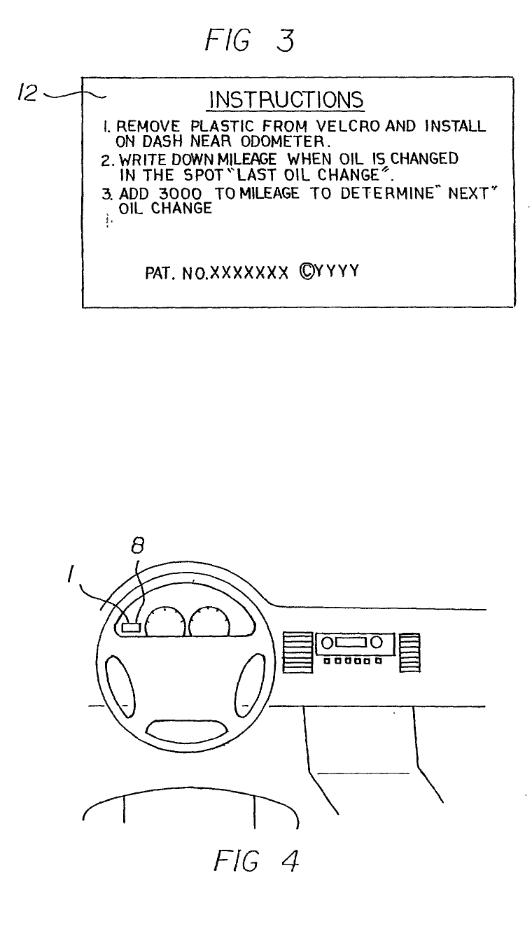

FIG. 3 shows a front view of instruction card 12 of the present invention. Instruction card 12 is preferably 1¾ inch tall and 1¾ inch wide and reads as follows:

### INSTRUCTIONS

1. REMOVE PLASTIC FROM VELCRO AND INSTALL ON DASH NEAR ODOMETER

2. WRITE DOWN MILEAGE WHEN OIL IS CHANGED IN THE SPOT “LAST OIL CHANGE”

3. ADD 3000 TO MILEAGE TO DETERMINE “NEXT OIL CHANGE”

FIG. 4 shows one of several preferred places for the attachment of notepad 2 of oil change reminder 1 Oil change reminder 1 would preferably be placed on a dashboard near the odometer of a vehicle, which will always keep the present invention within “line of sight” of a user and provide a constant reminder for the need to carefully monitor the oil changes in that vehicle. A user would mount oil change reminder 1 by placing male Velcro tab 10 onto female Velcro tab 8, which would be fixedly mounted onto the dashboard of a particular vehicle in a specific location.

Notepad 2 of oil change reminder 1 would preferably be made available in one of eight different colors, with all eight colors having black writing. The eight colors would be white, tan, gray, red, blue, yellow, green, and purple.

What I claim as my invention is:

1. An oil change reminder apparatus comprising
(a) a plurality of pages, each page having two surfaces, a front surface and a rear surface, each page being approximately one inch in height and one and one-half inches in width, the plurality of pages preferably including at least twenty-five pages, each page preferably including at least five lines of printing on the front surface of each page, the five lines of printing including a first line of printing, a second line of printing, a third line of printing, a fourth line of printing, and a fifth line of printing,
(b) a backing, the backing including a front surface and a rear surface, the plurality of pages being attached to the front surface of the backing, and
(c) attachment means for attaching the oil reminder apparatus to a flat surface.

2. An oil change reminder apparatus according to claim 1, wherein the first line of printing would state “LAST OIL CHANGE,” further wherein the second line of printing would have a blank line, further wherein the third line of printing would state “NEXT OIL CHANGE,” further wherein the fourth line of printing would be a blank line, further wherein the fifth line of printing would include printed references to one or more types of intellectual property protection that the oil change reminder apparatus would either possess or have filed on its behalf.

3. An oil change reminder apparatus according to claim 1, wherein the attachment means for attaching the oil reminder apparatus to a flat surface further comprises:
(a) A male Velcro tab fixedly attached to the rear surface of the backing,
(b) A female Velcro tab fixedly attached to a flat surface within eyesight of and in front of a driver of a vehicle,
(c) wherein the male Velcro tab would be removably attached to the female Velcro tab.

4. An oil change reminder apparatus according to claim 1, wherein the flat surface would preferably be a dashboard.
